(19) United States
(12) Patent Application Publication
(10) Pub. No.: US 2018/0167876 A1
(43) Pub. Date: Jun. 14, 2018

(54) MODULATION SCHEME FOR WIRELESS COMMUNICATIONS

(71) Applicant: QUALCOMM Incorporated, San Diego, CA (US)

(72) Inventor: Anthony MCFARTHING, Ely (GB)

(21) Appl. No.: 15/374,335

(22) Filed: Dec. 9, 2016

(51) Int. Cl. H04W 52/02; H04W 4/00; H04L 25/03; H04L 7/033

(52) U.S. Cl. CPC H04W 52/0209; H04L 7/033; H04L 25/03273; H04W 4/008

(57) ABSTRACT

Various aspects described herein relate to techniques and modulation schemes used in near-field communications systems. A method for near-field communications is provided that may include receiving a signal including an unmodulated carrier frequency, locking onto the unmodulated carrier frequency, and recovering a data clock frequency from the unmodulated carrier frequency based on a relationship between the data clock frequency and the unmodulated carrier frequency.

### BACKGROUND

Aspects of the present disclosure relate generally to wireless communications systems, and more particularly, to techniques and modulation schemes used in near-field magnetic communications systems.

A near-field magnetic communications system is a short range wireless communications system that communicates by coupling a tight, low-power, magnetic field between devices. Near Ultra-low Energy Field (NULEF) communications, a type of near-field magnetic communications, are similar to short range communications such as Near Field Communication (NFC) which has short-range and low-power capabilities, and the communication of data between a NULEF transmitter and a NULEF receiver is achieved by means of magnetic field induction. For near-field magnetic communication devices (e.g., NULEF devices or body worn devices), communications may use magnetic fields instead of transverse electromagnetic (EM) waves which may require real radiated power. In some examples, magnetic communications may have some advantages over EM communications, such as power dissipation and beneficial fading characteristics.

To save power, in some current implementations, a communications system (e.g., a NULEF communications system) may replace one or more traditional high-current power consumption components (e.g., a power amplifier (PA)) with something that is relatively tiny with low power consumption, while the rest of the communications system (e.g., a NULEF transceiver) cannot be capable of low power operation(s).On the other hand, in some current implementations, there has been a progression in design away from analog implementation to digital implementation for producing a communications device (e.g., a NULEF communications device). For designing analog circuits, one of the parameters that is known and has driven design is power dissipation, and power dissipation may have been under control. For designing digital circuits (e.g., digital signal processors (DSPs)), however, the power dissipation in some current implementations may be an issue. For example, the power dissipation in digital circuits may be discovered at a late point or not early enough in a design cycle, and maybe, for example, at a stage where little or nothing can be done to reduce power levels if the power levels are excessive.

Therefore, for improving a wireless communications system (e.g., a near-field magnetic communications system), components such as a transceiver may need to be capable of low power operation(s) in order to reduce power dissipation and increase the time between battery charges. In addition, in order to reduce the potential for an unexpected power impact, proper modulation schemes may be desired for wireless communications which may minimize the amount of digital processing, and reduce power consumption in order to produce power-efficient communications devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

According to an example, a method related to techniques and modulation schemes used for near-field communications is provided. The method includes receiving a signal including an unmodulated carrier frequency, locking onto the unmodulated carrier frequency, and recovering a data clock frequency from the unmodulated carrier frequency based on a relationship between the data clock frequency and the unmodulated carrier frequency.

In an aspect, an apparatus for near-field communications is provided. The apparatus may include means for receiving a signal including an unmodulated carrier frequency, means for locking onto the unmodulated carrier frequency, and means for recovering a data clock frequency from the unmodulated carrier frequency based on a relationship between the data clock frequency and the unmodulated carrier frequency.

In another aspect, another apparatus for near-field communications is provided. The apparatus may include a receiver configured to receive a signal including an unmodulated carrier frequency from a transmitter, and at least one processor configured to lock onto the unmodulated carrier frequency and recover a data clock frequency from the unmodulated carrier frequency based on a relationship between the data clock frequency and the unmodulated carrier frequency.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of aspects described herein, reference is now made to the accompanying drawings, in which like elements are referenced with like numerals. These drawings should not be construed as limiting the present disclosure, but are intended to be illustrative only.

FIG. 1 is a schematic block diagram of an example of a magnetic communications system including at least two near-field magnetic devices in communication with each other using modulation scheme(s) according to one or more of the presently described aspects.

FIG. 2 is a schematic representation of a circuit implementation of a near-field transceiver according to one or more of the presently described aspects.

FIG. 3 is a constellation diagram of an example of a modulation scheme including a modulated quadrature phase shift keying (QPSK) signal and a residual carrier for transmission, according to one or more of the presently described aspects.

FIG. 4 is a spectrum of an example of signals with each signal having a modulated carrier portion and a residual unmodulated carrier portion, according to one or more of the presently described aspects.

FIG. 5 is a flow diagram of an example of a method of modulation scheme used for near-field communications, according to one or more of the presently described aspects.

### DETAILED DESCRIPTION

In some current implementations, a communication system may use received modulated signal(s) for carrier and/or symbol timing recovery. In an example, the symbol timing recovery estimates a timing offset, and the timing recovery or correction is derived from the timing offset (e.g., a phase error). The timing offset or a phase error signal may be generated from a modulation constellation distribution. In addition, the carrier frequency of a carrier may be not related in a numerical way to a modulation symbol frequency in some current implementations. The present disclosure, in an example, relates to inclusion of an unmodulated carrier component into a signal for communication. In an aspect, the proposed wireless communications system (e.g., a near-field magnetic or a Near Ultra-low Energy Field (NULEF) communications system) may use prior knowledge of a relationship between the symbol timing (e.g., the modulation symbol frequency or a data clock frequency) and the carrier frequency (modulated or unmodulated), and the carrier and the symbol timing signals may be recovered or extracted from the unmodulated portion of the received modulated carrier instead of using a timing offset or a phase error signal generated from processing of the modulation. In another aspect, the process of generating a symbol timing clock from the recovered carrier may generate a phase ambiguity. In an example, the phase ambiguity may require a small amount of processing to rectify, and the processing to resolve the phase ambiguity may be part of the coherent carrier and symbol timing recovery.

Additionally, some current communication systems may use multiplicative and/or non-linear processing to recover the frequency or the phase of a received signal. In these systems, a residual carrier frequency offset, a difference between the carrier frequency and a local oscillator (LO) for carrier reception, may be used for symbol timing recovery. Instead of using the residual carrier frequency offset, this disclosure, in an example, relates to using a residual carrier component which may be an unmodulated carrier component added to the transmitted signal for carrier recovery, and symbol timing or data clock recovery.

In a current implementation, a carrier signal may be suppressed if extra power is transmitted on the carrier signal, and such suppression may reduce an error vector magnitude (EVM) and consequently, have a lower bit error rate (BER). In addition, intermodulation may place limits on levels of an unmodulated carrier, which may not be reduced in intensity levels by filtering. However, such limitations may not exist because a magnetic communications system (e.g., a NULEF communications system) discussed herein are different from those of conventional EM communication system spectrums, and may not have any of the usual spectrum limitations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. In some aspects, the computer-readable media may be non-transitory or include a non-transitory computer-readable storage medium.

In some implementations, power savings may be achieved through the use of high-level modulation formats which increases the number of bits per symbol transmitted, thereby allowing a NULEF transceiver to operate with a low duty cycle (e.g., a ratio of off time to on time). In some aspects, near-field such as NULEF communications may be converted from a burst mode format with high data rate(s) to a lower continuous format, and still satisfy a predetermined minimum data rate throughput requirements.

In some implementations, orthogonal frequency division multiplexing (OFDM) may be used in near-field (e.g., NULEF) communications, and a number of digital processing may be required. However, even with the burden of a large digital processing overhead, OFDM may still be an energy-efficient system, especially when the benefits of OFDM are included or considered (e.g., allowing poorer channel amplitude(s) and group delay characteristics).

In some aspects, one or more high digital overheads involved with a demodulator (e.g., carrier frequency and/or symbol timing recovery) in a transceiver (e.g., a NULEF transceiver) may be eliminated. In an aspect, an overhead for equalization may affect a NULEF communications system, however, the impact may be relatively small. In some examples, some aspects described herein may relate or apply to various modulation schemes, for example, binary phase-shift keying (BPSK), quadrature phase shift keying (QPSK), offset-keyed quadrature phase shift keying (OK-QPSK), and/or quadrature amplitude modulation (QAM) (e.g., 64-QAM, 128-QAM, or 1024-QAM). In some implementations (e.g., using phase shift keying (PSK)), there may be some requirements to reduce or limit the level of an unmodulated carrier. In some wireless communication standards (e.g., IEEE 802.11 or Wi-Fi), the specifications may require or suggest setting a limit for the level of the unmodulated carrier. In some aspects, there may be no communication standards that affect impose spectral limitations or any other limitations on magnetic communications.

Various aspects are described herein relate to a transceiver (e.g., a NULEF transceiver) for use in a communications system that uses magnetic fields to transmit and receive signals and/or data. In an aspect, as discussed above, to reduce power consumption, the transceiver (e.g., a NULEF transceiver) may be simplified by removing some components or circuits (e.g., digital processing components or circuits) that consume high power (e.g., with high digital overheads). In some examples, suitable modulation scheme(s) may be required for near-field communications (e.g., NULEF communications) to minimize the amount of digital design and/or digital processing in order to reduce power consumption. In other words, in order to produce power efficient devices, new approaches or designs for modulation formats or schemes may be needed.

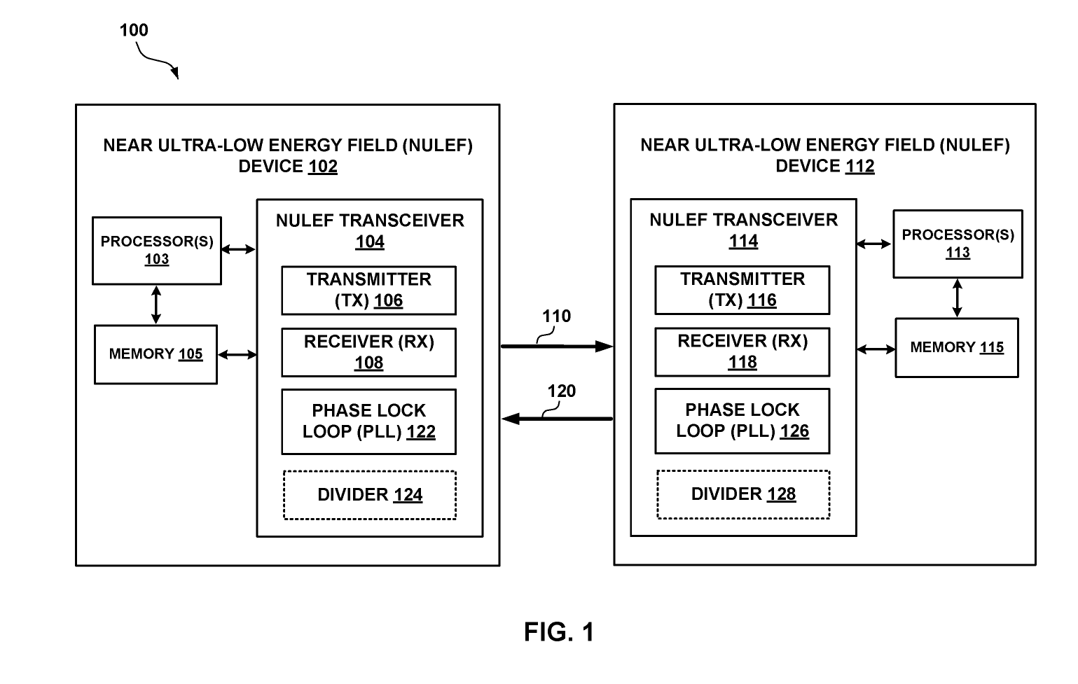

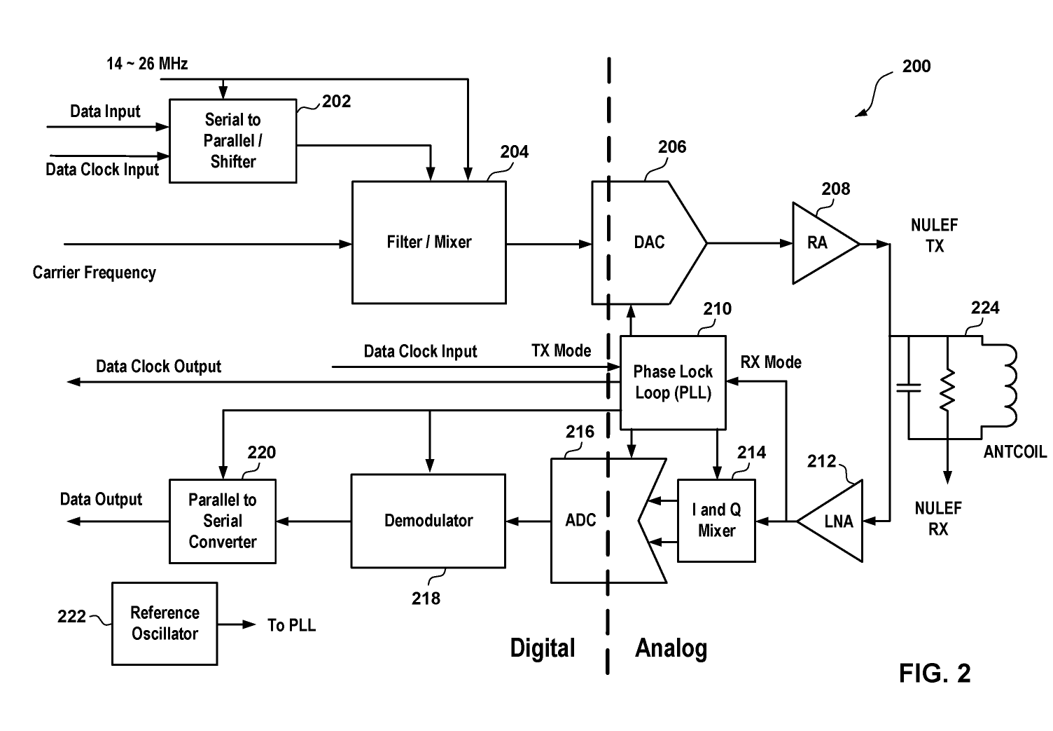

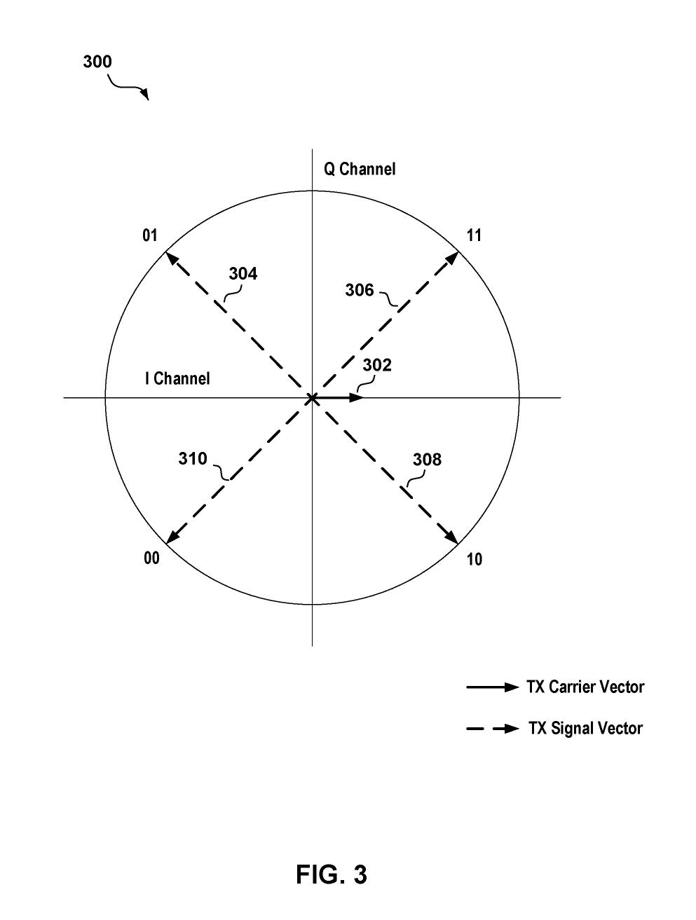

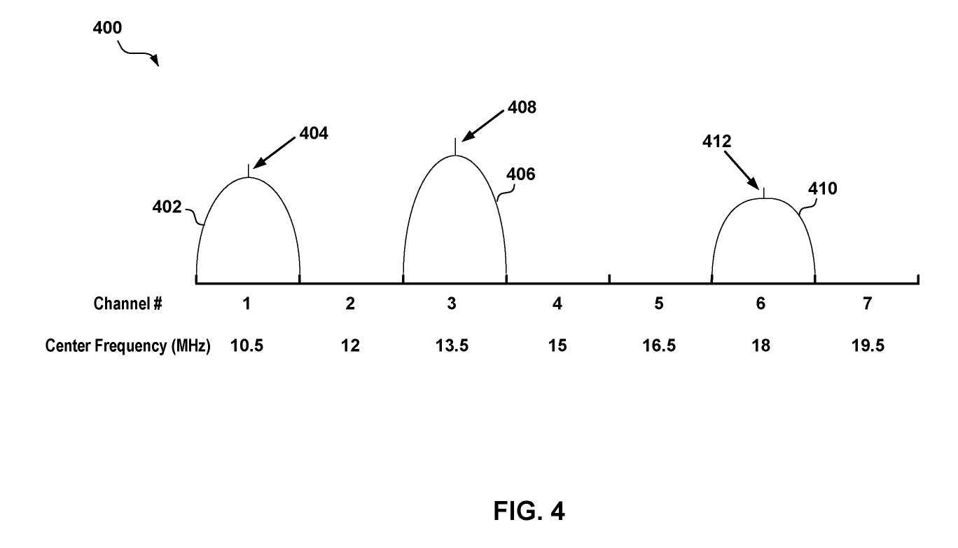

In an aspect, a new modulation scheme for low-energy near-field communications (e.g., NULEF communications) may be used to eliminate or reduce, in a NULEF transceiver (e.g., NULEF transceivers 104 and 114 shown in FIG. 1, and/or NULEF transceiver 200 shown in FIG. 2), the need for high digital overheads involved with a demodulator (e.g., a demodulator connected to a phase lock loop (PLL)) such as symbol timing and/or carrier frequency recovery. In some examples, the new modulation scheme provides transmitting a modulated data signal (e.g., a QPSK signal) as well as a residual carrier (e.g., a residual unmodulated carrier) together, which is shown in FIGS. 3 and 4. In some examples, the transmitted carrier may include a low level of a modulated carrier and a residual unmodulated carrier with a fixed carrier vector. In other words, an unmodulated carrier component may be included in or purposely injected onto a modulated signal for transmission.

In another aspect, in some non-coherent demodulation schemes, a symbol timing recovery signal may be generated. On the other hands, in some coherent demodulation schemes, both a carrier recovery signal and a symbol timing recovery signal may be required or generated. In some examples, the new modulation scheme using an unmodulated component (e.g., a low level unmodulated component) as part of the transmitted modulated signal may be used to recover the carrier in addition to the data clock.

In an aspect, a low level clock signal may be injected onto a modulated signal, and from which a PLL may lock. Accordingly, in an example, a recovered clock may be generated without any non-linear processing(s). In some examples, a non-coherent carrier demodulation scheme may be used although the PLL may be configured to recover a coherent carrier, because there may be a defined relationship between the carrier and symbol timing clock at the transmitter. In some examples, the new modulation scheme used for a coherent carrier recovery may provide a better BER performance for a coherent carrier demodulation than a non-coherent demodulation.

In some examples, the carrier frequency may be related in a numerical way to the data clock frequency or symbol timing. This numerical relationship, a prior knowledge to a NULEF communications system or a NULEF device, may be used for symbol timing or data clock frequency recovery. For example, the symbol timing or data clock frequency may be extracted or recovered from the transmitted or received carrier frequency based on the numerical relationship. In an implementation, the numerical relationship may indicate that the carrier frequency is a multiple (e.g., an integer multiple) of the data clock frequency, the symbol timing or data clock frequency may be extracted or recovered by dividing or multiplying the carrier frequency by the multiple indicated by the numerical relationship.

In an aspect, when using the new modulation scheme, a NULEF transceiver or a NULEF receiver may become simplified, as shown in FIG. 2. In NULEF communications, the modulation scheme may use the received residual carrier (e.g., a residual unmodulated carrier) for symbol timing and/or carrier recovery. For example, as shown in FIG. 2, in a receive (RX) mode, a PLL at the transceiver or receiver may lock onto the received residual carrier and may effectively produce a coherent carrier signal for a coherent mixer. Because the NULEF transmitter in this system produces and transmits a carrier frequency that is related to a transmitter clock (e.g., the carrier frequency may be a multiple of the transmitter clock frequency), after the PLL has locked to the transmitted signal, the symbol timing or received data clock may be determined or recovered by the PLL, based on a relationship between the clock and the received carrier frequency, without the need for additional recovery circuitry. In some examples, both the carrier frequency and the relationship between the clock and the carrier frequency are known to the NULEF communications system, therefore, the symbol timing, data clock, and/or the carrier frequency may be reversed or recovered at the NULEF receiver. As such, components used for symbol timing and carrier frequency recovery may not be necessary in the NULEF receiver. As a result, for example, the digital overheads from symbol timing and/or carrier frequency recovery may be eliminated or reduced.

In some examples, a divider (e.g., one or more dividers 124 and 128 in FIG. 1) may be associated with the PLL in a NULEF transceiver. The divider, for example, may be implemented separately from the PLL as shown in FIG. 1 or may be integrated with the PLL (not shown). In an aspect, the divider may be used or configured to operate with other components for obtaining the clock from the carrier signal. For example, the divider may be used to create a coherent data clock or symbol timing clock from the recovered carrier signal. In an aspect, there may be digital overhead(s) for equalization, which may be caused by the divider. In another aspect, one or more digital components (e.g., a phase ambiguity resolver) for symbol timing recovery may be included or added in the NULEF receiver to resolve or correct a phase ambiguity, if any.

In an aspect, in a NULEF communications system or a NULEF device, carrier phase ambiguity may be resolved by, for example, using differential encoding(s). In another aspect, in a NULEF communications system or a NULEF device, insufficient spreading of modulation may be resolved by, for example, using a self-synchronizing scrambler/descrambler.

Referring to FIG. 1, in an aspect, a magnetic communications system 100 includes at least two NULEF devices 102 and 112. In some examples, NULEF device 102 may communicate with NULEF device 112 via wireless (e.g., magnetic) communications 110 and/or 120. In some aspects, multiple NULEF devices including NULEF device 102 may be in magnetic field communications coverage with one or more NULEF devices, including NULEF device 112. In an example, NULEF device 102 may transmit and/or receive wireless communications (e.g., magnetic communications) to and/or from NULEF device 112.

In some aspects, NULEF device 102 or 112 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A NULEF device 102 or 112 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc.), an appliance, a sensor, a vehicle communication system, a medical device, a vending machine, a device for the Internet-of-Things (IoT), or any other similar functioning device.

According to the present aspects, NULEF device 102 may include one or more processors 103, a memory 105, and/or a NULEF transceiver 104. In some examples, the NULEF transceiver 104 may have some subcomponents including a transmitter (TX) 106, a receiver (RX) 108, a phase lock loop (PLL) 122, and/or a divider 124 (optional) for operating and/or managing modulation schemes used in NULEF communications according to one or more of the described aspects herein. Similarly, NULEF device 112 may include one or more processors 113, a memory 115, and/or a NULEF transceiver 114. In some examples, the NULEF transceiver 114 may have some subcomponents including a transmitter (TX) 116, a receiver (RX) 118, a phase lock loop (PLL) 126, and/or a divider 128 (optional) for operating and/or managing modulation schemes used in NULEF communications according to one or more of the described aspects herein. In some examples, the one or more processors 103 and/or the memory 105 in the NULEF device 102 may operate in combination with the NULEF transceiver 104 for operation or management of certain aspects as described herein. Similarly, the one or more processors 113 and/or the memory 115 in the NULEF device 112 may operate in combination with the NULEF transceiver 114 for operation or management of certain aspects as described herein.

In an aspect, the term “component” as used herein may be one of the parts that make up a system, may be hardware, firmware, and/or software, and may be divided into other components. In some examples, NULEF transceiver 104/114, TX 106/116, RX 108/118, PLL 122/126, and/or divider 124/128 may be communicatively coupled to one or more additional components (e.g., one or more processors 103/113 or memory 105/115) for transmitting, receiving, and/or processing radio frequency (RF) and/or magnetic signals.

In an aspect, RX 108/118 may include hardware, firmware, and/or software code executable by a processor (e.g., processor 103/113) for receiving data, the code comprising instructions and being stored in a memory (e.g., memory 105/115). The RX 108/118 may be, for example, a RF or a NULEF receiver.

In another aspect, the TX 106/116 may include hardware, firmware, and/or software code executable by a processor (e.g., processor 103/113) for transmitting data, the code comprising instructions and being stored in a memory (e.g., computer-readable medium). The transmitter (TX) 106/116 may be, for example, a RF or a NULEF transmitter.

In an aspect, the PLL 122/126 may include hardware, firmware, and/or software code executable by a processor (e.g., processor 103/113) to operate in a TX mode and perform with the TX 106/116, and/or in a RX mode and perform with the RX 108/118. For example, when the PLL 122 or 126 is configured to operate in the RX mode according to the instructions being executed by one or more processors 103/113, the PLL 122 or 126 may be enabled to perform a division by a multiple. In an aspect, the multiple may be identified or determined, for example, as part of enabling the operation of the PLL 122 or 126 in the RX mode. In another example, the PLL 122 or 126 may be enabled to perform a multiplication by a multiple, and similarly, the multiple may be identified or determined, for example, as part of enabling the operation of the PLL 122 or 126 in the RX mode. In an aspect, the multiple may be identified, determined, or indicated by a numerical relationship between the carrier frequency and the data clock frequency according to one or more aspects discussed herein.

In another aspect, the divider 124/128 may include hardware, firmware, and/or software code executable by a processor (e.g., processor 103/113) to perform a division by a multiple (e.g., an integer multiple). In an aspect, the multiple may be identified, determined, or indicated by a numerical relationship between the carrier frequency and the data clock frequency according to one or more aspects discussed herein. In an example, the divider 124/128 may be implemented separately from the PLL 122/126. In another example, the divider 124/128 may be integrated with the PLL 122/126.

In an aspect, various functions related to NULEF transceiver 104/114 may be executed by a single processor, while in other aspects, different ones of the functions may be executed by a combination of two or more different processors. For example, in an aspect, one or more processors 103/113 may include any one or any combination of a modem processor, or a baseband processor, or a digital signal processor (DSP), or a transmit processor, or a transceiver processor associated with NULEF transceiver 104/114. In particular, the one or more processors 103/113 may implement components included in the NULEF transceiver 104/114.

In another aspect, one or more processors (e.g., processor 103/113) in a NULEF device (e.g., NULEF device 102/112) may execute or process instructions stored in a memory (e.g., memory 105/115) to assist/support or direct/instruct operation(s) of TX 106/116, RX 108/118, PLL 122/126, and/or divider 124/128. In an example, a relationship (e.g., a numerical relationship or a multiple) may be stored in memory 105/115 and identified by processor 103/113 to instruct PLL 122/126 to perform a signal recovery (e.g., a data clock or symbol timing recovery). In an aspect, the numerical relationship may indicate that the carrier frequency is a multiple (e.g., an integer multiple) of the data clock frequency. When the PLL 122/126 is operated in a receive (RX) mode according to the instructions being executed by one or more processors 103/113, the PLL 122/126 may be enabled to perform a multiplication or a division by the multiple in order for the PLL 122/126 to obtain the data clock frequency. In another example, a particular relationship (e.g., a numerical relationship) may be pre-programmed or pre-configured on the PLL 122/126, and the PLL 122/126 may apply, for example, a proper multiple for the conversion and/or for data clock or symbol timing recovery.

Referring to FIG. 2, in an example, a NULEF transceiver 200 (e.g., NULEF transceiver 104/114 in FIG. 1) in a magnetic communications system may include part or all of the components shown in FIG. 2. In an aspect, the NULEF transceiver 200 may include a transmitter (e.g., TX 106/116 in FIG. 1), a receiver (e.g., RX 108/118 in FIG. 1), a phase lock loop (PLL) (e.g., PLL 122/126 in FIG. 1), and/or optionally a divider (e.g., divider 124/128 in FIG. 1). In some examples, the NULEF transceiver 200 (e.g., NULEF transceiver 104/114) or the subcomponent TX 106/116 may include a serial-to-parallel (S/P) convertor/shifter 202. In an example, the Shifter may be a four-symbol shifter. In an operational aspect, the S/P convertor/shifter 202 may obtain data (e.g., at 2 Mbps), data clock (e.g., at 1 MHz) and/or a reference signal (e.g., in the range of 14 MHz to 26 MHz, generated by an oscillator) as input, and subsequently output the processed signal(s) or data to a Filter/Mixer 204 (e.g., a look-up table (LUT), a finite impulse response (FIR) filter, and/or a carrier frequency). In some examples, the reference signal (e.g., in the range of 14 MHz to 26 MHz), and/or a carrier frequency may be obtained as input at the filter/mixer 204. The carrier frequency of the signals or data may be in the range of 10 MHz to 20 MHz. For example, the carrier frequency may be one of 10.5 MHz, 12 MHz, 13.5 MHz, 15 MHz, 16.5 MHz, 18 MHz, or 19.5 MHz.

In an aspect, a digital-to-analog converter (DAC) 206 converts a digital signal (e.g., the output of the filter/mixer 204) into an analog signal, and then pass to a power amplifier (RA) 208 for signal amplification, before transmitting the signal via one or more front-end circuits 224 (e.g., one or more magnetic coils, antennas, or antcoils). In some implementations, the relatively low frequency characteristics of most magnetic coils, antennas, or antcoils for short range communications (e.g., that are used in NFC applications to generate the required magnetic field) may be caused by low self-resonant frequencies of NFC antcoils. However, with careful design, the maximum frequency of a NULEF communications system may be increased in some aspects.

In another aspect, at the receive section of the NULEF transceiver 104/114, or subcomponent RX 108/118 may include a low noise amplifier (LNA) 212 having signals or data input from the front-end circuits 224 by magnetic field induction. Where the NULEF transceiver 104/114 incorporating a phase lock loop (PLL) 210 is operating in a receive (RX) mode, the signals and/or data will be input to the PLL 210 and an in-phase and quadrature (I and Q, or I/Q) mixer 214. The I and Q (I/Q) mixer 214 may receive signal(s) from the PLL 210, and send signals or data to an analog-to-digital converter (ADC) 216. In some aspects, where the NULEF transceiver 104/114 incorporating the PLL 210 is operating in a transmit (TX) mode, the PLL 210 may have data clock input, for example, at 1 MHz. In other words, the PLL 210 may be configured to operate in the RX mode or the TX mode, and a NULEF signal is received when the PLL 210 is configured to operate in the RX mode.

Still referring to FIG. 2, in an aspect, when the PLL 210 operates in the RX mode, the PLL 210 may lock onto a received residual carrier frequency (e.g., an unmodulated carrier frequency) and may effectively produce a coherent carrier signal for a coherent mixer or a demodulator 218 (e.g., a coherent digital demodulator). In some examples, because the NULEF transmitter (e.g., TX 106/116) in this NULEF communications system may produce and transmit the carrier frequency (e.g., shown in FIGS. 3 and 4) that may be related to the data clock in the NULEF transmitter (e.g., the carrier frequency may be a multiple of the transmitter clock frequency), after the PLL 210 has locked to the transmitted signal or carrier frequency, the symbol timing or received data clock may be determined or identified by the PLL 210 based on a relationship between the data clock and the received carrier frequency, without the need for additional recovery circuitry. For example, when the PLL 210 operates in the RX mode, the PLL 210 may be configured to determine or identify a relationship between the data clock and the received carrier frequency. The relationship may be a numerical relationship, and may indicate that the carrier frequency is a multiple (e.g., an integer multiple) of the data clock frequency. The PLL 210 may be configured to perform a division or an effective multiplication operation by the indicated multiple. In an aspect, the multiple is identified as part of enabling the operation of the PLL 210 in the RX mode. In another example, dividers 124/128 (shown in FIG. 1) may be included and configured to perform the division or the effective multiplication in order to identify or recover the data clock and the received carrier signal. In an example, the divider 124/128 may be implemented separately from the PLL 122/126. In another example, the divider 124/128 may be integrated with the PLL 122/126. In an aspect, the divider 124/128 may be configured with the PLL 122/126 to perform a multiplication, for example, when a voltage-controlled oscillator (VCO) output frequency is related to a lower frequency phase detector frequency.

In some aspects, both the carrier frequency and the relationship are known to the NULEF communications system, therefore, the symbol timing/data clock and the carrier frequency may be reversed or recovered at the NULEF transceiver (e.g., NULEF transceiver 104/114). As such, in some examples, the components or circuitries for symbol timing and/or carrier frequency recovery may be unnecessary in the NULEF receiver. As a result, the digital overheads typically generated from symbol timing and/or carrier frequency recovery may be eliminated or reduced to save power consumption.

Moreover, in an aspect, the PLL 210 may obtain a reference signal from a reference oscillator 222 (e.g., a reference crystal oscillator), and operate at a frequency, for example, in the range of 14 MHz to 26 MHz, or in the range of 48 MHz to 104 MHz. In some examples, after the symbol timing or received data clock is determined by the PLL 210 based on the relationship between the data clock and the received carrier frequency, the PLL 210 may send signals or data to the I and Q (I/Q) mixer 214 and the ADC 216, output the determined data clock (e.g., at 1 MHz), output the reference signal (e.g., in the range of 14 MHz to 26 MHz) to the coherent mixer or the demodulator 218, and/or output the received carrier frequency to a parallel-to-serial (P/S) converter 220 or the demodulator 218. After all, the data (e.g., at 2 MHz) which has processed may be output by the P/S converter 220.

Referring to FIG. 3, in an aspect, a constellation diagram 300 represents a signal modulated by a modulation scheme including a modulated signal (e.g., a QPSK signal) and a residual unmodulated carrier for transmission or reception by the NULEF device 102 or 112 (FIG. 1). In an example, the NULEF transceiver 200 in FIG. 2 may be configured to transmit signals using the modulation scheme with the constellation diagram 300, or configured to receive and process signals using the modulation scheme with the constellation diagram 300. The modulated signal, a QPSK signal for example, uses four points on the constellation diagram 300, which are equally spaced around a circle. With four phases, the modulated QPSK signal may encode two bits per symbol (e.g., 01, 11, 10, and 00), as shown FIG. 3. In an example, the residual unmodulated carrier may be transmitted and presented by a transmit (TX) carrier vector 302, while the modulated QPSK signal may be transmitted and presented by one or more transmit (TX) signal vectors 304, 306, 308 and 310. In an aspect, the amplitude of the residual unmodulated carrier may affect acquisition time of the PLL 210 (e.g., in the RX mode). For example, a lower residual unmodulated carrier may be transmitted for a continuous mode, and/or a higher residual unmodulated carrier may be transmitted for a burst mode. In an aspect, the TX carrier vector 302 or one or more TX signal vectors 304, 306, 308 and 310 may be a fixed vector or vectors. In an example, the fixed vector or vectors may be associated with a fixed phase offset or offsets. In an aspect, the constellation diagram 300 may represent a QPSK coherent reception assist.

Referring to FIG. 4, in an example, frequency spectrum 400 includes three NULEF signals for transmission and/or for NULEF channel allocation by the NULEF device 102 or 112. In particular, each NULEF signal may have a modulated portion (e.g., modulated carrier and/or data) with a relevantly low power level and a residual unmodulated carrier portion with a relevantly high power level. For example, NULEF signals 402, 406, and 410 may have center frequencies at 10.5 MHz (Channel No. 1), 13.5 MHz (Channel No. 3), and 18 MHz (Channel No. 6), respectively. The lower level portions of NULEF signals 402, 406, and 410 may include modulated data and carriers, while at least part of residual unmodulated carriers 404, 408, and 412 are shown at the top and center of NULEF signals 402, 406, and 410, respectively. In some examples, the residual unmodulated carriers 404, 408, and 412 may be presented by TX carrier vector 302 in FIG. 3, and may be transmitted by the NULEF transceiver 104/114 in FIG. 1, and/or the NULEF transceiver 200 in FIG. 2.

In another example, at NULEF receiver side (e.g., RX 108/118, or NULEF transceiver 104/114) of the NULEF device 102 or 112, the received signals may have a same or similar frequency spectrum as shown in FIG. 4. For example, the three NULEF signals 402, 406, and 410 in frequency spectrum 400 may be three received NULEF signals. In particular, each received NULEF signal may have a modulated portion (e.g., modulated carrier and/or data) with a relevantly low power level and a residual unmodulated carrier portion with a relevantly high power level. For example, NULEF signals 402, 406, and 410 may have center frequencies at 10.5 MHz (Channel No. 1), 13.5 MHz (Channel No. 3), and 18 MHz (Channel No. 6), respectively. The lower level portions of the received NULEF signals 402, 406, and 410 may include modulated data and carriers, while at least part of residual unmodulated carriers 404, 408, and 412 are shown at the top and center of NULEF signals 402, 406, and 410, respectively. In some examples, the residual unmodulated carriers 404, 408, and 412 may be presented by TX carrier vector 302 in FIG. 3, and may be received by the NULEF transceiver 104/114 in FIG. 1, and/or the NULEF transceiver 200 in FIG. 2.

Still referring to FIG. 4, in an aspect, frequency spectrum 400 may include or represent a master/slave arrangement using a simplex NULEF channel allocation. In an example, Channel No. 6 may be assigned a simplex mode between two or more NULEF transceivers (e.g., the NULEF transceiver 104/114). One of the NULEF transceivers (e.g., the NULEF transceiver 104 or 114) may act as a master and impose a time division multiplexing (TDM) format for a link where specific time slots would be allocated for transmission and reception. The other NULEF transceivers (e.g., two or more NULEF transceivers) may be allocated a different channel so that NULEF communications may incorporate aspects of both frequency division multiplexing (FDM) and TDM. In an aspect, another channel may be allocated to two NULEF transceivers (e.g., using FDM) positioned in a person's ears, while a third transceiver located in the same person's pocket (e.g., at the person's hip) to generate an Ear-to-Ear-to-Hip link. A TDM format may be applied to the link by a nominated master to allow intercommunication between all three parties (e.g., the three NULEF transceivers). In an aspect, a specific data throughput may be guaranteed by using high-level modulation formats. For example, an Ear-to-Ear operation may use one or more aspects discussed herein (e.g., using residual unmodulated carriers for data clock or symbol timing recovery) to simplify digital design and reduce power dissipation.

For purposes of simplicity of explanation, the methods discussed herein are shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

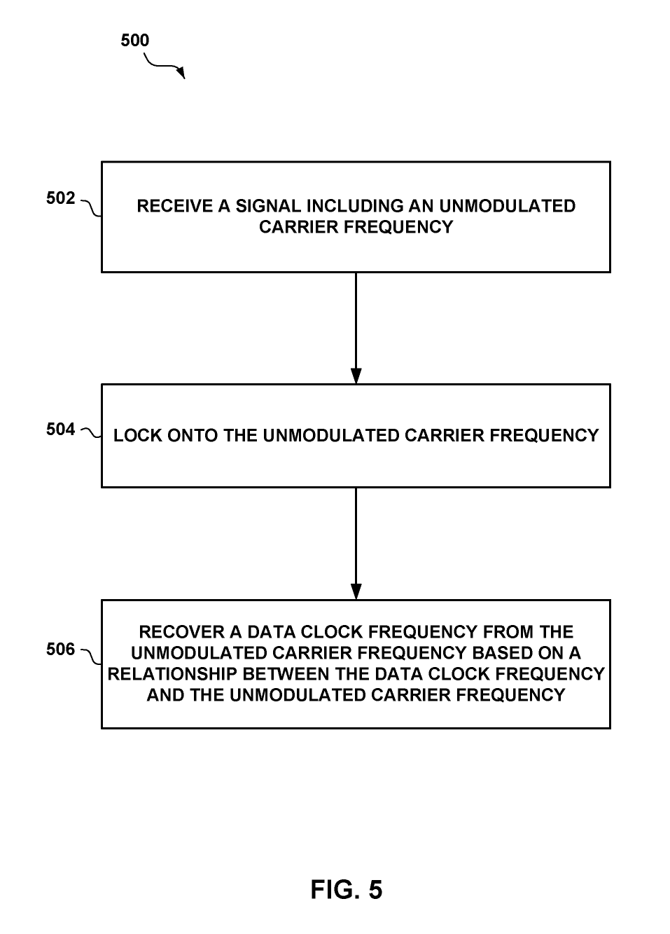

Referring to FIG. 5, in an operational aspect, a near-field communications device such as the NULEF device 102 or 112 (FIG. 1) may perform one or more aspects of a method 500 for near-field communications. For example, NULEF transceiver 104/114, TX 106/116, RX 108/118, PLL 122/126, divider 124/128 (optional), one or more processors 103/113, a memory 105/115, and/or one or more other components, may be configured to perform aspects of the method 500.

In an aspect, at block 502, the method 500 may include receiving a signal including an unmodulated carrier frequency. In an aspect, for example, NULEF transceiver 104/114, and/or RX 108/118 (FIG. 1) may be configured to receive one or more signals (e.g., NULEF signals 402, 406, and/or 410 in FIG. 4), and each signal (e.g., NULEF signal 402, 406, or 410) may include at least an unmodulated carrier frequency (e.g., residual unmodulated carrier 404, 408, or 412 in FIG. 4).

In another aspect, at block 504, the method 500 may include locking onto the unmodulated carrier frequency. In an aspect, for example, NULEF transceiver 104/114, RX 108/118, and/or PLL 122/126 (FIG. 1) may be configured to lock onto the received unmodulated carrier frequency (e.g., residual unmodulated carrier 404, 408, or 412).

In an aspect, at block 506, the method 500 may include recovering a data clock frequency from the unmodulated carrier frequency based on a relationship between the data clock frequency and the unmodulated carrier frequency. In an aspect, for example, NULEF transceiver 104/114, RX 108/118, PLL 122/126, divider 124/128 (optional), one or more processors 103/113, and/or memory 105/115, may be configured to perform data clock or symbol timing recovery from the received unmodulated carrier frequency (e.g., residual unmodulated carrier 404, 408, or 412) based on a relationship between the data clock frequency and the unmodulated carrier frequency. For example, if the relationship indicates that the unmodulated carrier frequency is a multiple of the data clock frequency at the transmitter, the NULEF device 102/112 or NULEF transceiver 104/114 may recover the data clock frequency or symbol timing by dividing or multiplying the unmodulated carrier frequency based on the relationship. In another example, the NULEF device 102/112 or NULEF transceiver 104/114 may recover the carrier at block 506 after locking onto the received unmodulated carrier frequency at block 504.

In another aspect of the method 500, the relationship may indicate that the unmodulated carrier frequency is a multiple of the data clock frequency.

In an aspect of the method 500, the relationship may indicate that the unmodulated carrier frequency is an integer multiple of the data clock frequency.

In another aspect, the method 500 may include determining the relationship between the data clock frequency and the unmodulated carrier frequency, wherein the relationship is a prior knowledge to a transceiver, for example, an indication of the relationship may be stored or configured into the transceiver. In an aspect, for example, NULEF transceiver 104/114, and/or one or more processors 103/113 may be configured to determine or identify the relationship between the unmodulated carrier frequency (e.g., residual unmodulated carrier 404, 408, or 412) and the data clock frequency of the transmitter (e.g., TX 106/116). In an example, the relationship may indicate that the unmodulated carrier frequency is a multiple of the data clock frequency (e.g., 10.5 times, 13.5 times, 18 times, etc.). The multiple, for example, may be an integer multiple or a fractional multiple of the data clock frequency. In an example, the relationship may be stored in memory 105/115, and may be determined or identified by one or more processors 103/113 to properly instruct or program the PLL 122/126 and/or the divider 124/128 in NULEF transceiver 104/114 to perform the needed recovery (e.g., data clock or symbol timing recovery). In another example, the relationship (e.g., a numerical relationship) may be pre-programmed or pre-configured on the PLL 122/126, and the PLL 122/126 may apply, for example, a proper multiple for the conversion and/or for data clock or symbol timing recovery.

In an aspect of the method 500, recovering the data clock frequency may comprise dividing the unmodulated carrier frequency by a multiple indicated by the relationship. In an aspect, for example, NULEF transceiver 104/114, PLL 122/126, and/or divider 124/128 may be instructed or configured to perform the division. In an example, the multiple indicated by the relationship may be stored in memory 105/115, and may be determined or identified by one or more processors 103/113 to properly instruct or program the PLL 122/126 and/or the divider 124/128 in NULEF transceiver 104/114 to perform the needed division(s).

In another aspect of the method 500, the signal may include modulated data, or a modulated carrier frequency, or both. In an aspect, for example, NULEF transceiver 104/114, and/or RX 108/118 may be configured to receive one or more NULEF signals, and in addition to the unmodulated carrier frequency, each NULEF signal may include modulated data or a modulated carrier frequency.

In an aspect of the method 500, the unmodulated carrier frequency may be a residual carrier frequency (e.g., residual unmodulated carrier 404, 408, or 412) or a fixed carrier vector (e.g., TX carrier vector 302).

In another aspect of the method 500, the unmodulated carrier frequency may be one of 10.5 MHz, 12 MHz, 13.5 MHz, 15 MHz, 16.5 MHz, 18 MHz, or 19.5 MHz.

In an aspect, the method 500 may include recovering a symbol timing from the unmodulated carrier frequency based on the relationship. In an aspect, for example, NULEF transceiver 104/114, RX 108/118, PLL 122/126, divider 124/128 (optional), one or more processors 103/113, and/or memory 105/115, may be configured to perform symbol timing recovery from the received unmodulated carrier frequency (e.g., residual unmodulated carrier 404, 408, or 412) based on the relationship between the data clock frequency and the unmodulated carrier frequency.

In another aspect of the method 500, locking onto the unmodulated carrier frequency may be performed at PLL 122/126 of NULEF transceiver 104/114.

In an aspect of the method 500, PLL 122/126 may be configured to operate in a RX mode or a TX mode, and the signal (e.g., one or more NULEF signals) may be received when the PLL 122/126 is configured to operate in the RX mode.

Several aspects of a magnetic communications system have been presented herein. As those skilled in the art will readily appreciate, various aspects described throughout this disclosure may be extended to other communications systems, network architectures and communication standards.

By way of example, various aspects may be extended to other communication systems such as a NFC system. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual network architecture, and/or communication standard employed will depend on the specific application and the overall design constraints imposed on the system.

It is to be understood that the specific order or hierarchy of steps in the methods disclosed is an illustration of examples or processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for near-field communications, comprising:
receiving a signal including an unmodulated carrier frequency;
locking onto the unmodulated carrier frequency; and
recovering a data clock frequency from the unmodulated carrier frequency based on a relationship between the data clock frequency and the unmodulated carrier frequency.

2. The method of claim 1, wherein the relationship indicates that the unmodulated carrier frequency is a multiple of the data clock frequency.

3. The method of claim 1, wherein the relationship indicates that the unmodulated carrier frequency is an integer multiple of the data clock frequency.

4. The method of claim 1, further comprising:
determining the relationship between the data clock frequency and the unmodulated carrier frequency, wherein an indication of the relationship is stored or configured into a transceiver.

5. The method of claim 1, wherein recovering the data clock frequency comprises dividing the unmodulated carrier frequency by a multiple indicated by the relationship.

6. The method of claim 1, wherein the signal further includes modulated data or a modulated carrier frequency.

7. The method of claim 1, wherein the unmodulated carrier frequency is a residual carrier frequency or a fixed carrier vector.

8. The method of claim 1, wherein the unmodulated carrier frequency is one of 10.5 MHz, 12 MHz, 13.5 MHz, 15 MHz, 16.5 MHz, 18 MHz, or 19.5 MHz.

9. The method of claim 1, further comprising:
recovering a symbol timing from the unmodulated carrier frequency based on the relationship.

10. The method of claim 1, wherein the locking onto the unmodulated carrier frequency is performed at a phase lock loop (PLL) of a transceiver.

11. The method of claim 10, wherein the PLL is configured to operate in a receive (RX) mode or a transmit (TX) mode, and wherein the signal is received when the PLL is configured to operate in the RX mode.

12. The method of claim 1, wherein the signal is a near ultra-low energy field (NULEF) signal.

13. An apparatus for near-field communications, comprising:
means for receiving a signal including an unmodulated carrier frequency;
means for locking onto the unmodulated carrier frequency; and
means for recovering a data clock frequency from the unmodulated carrier frequency based on a relationship between the data clock frequency and the unmodulated carrier frequency.

14. The apparatus of claim 13, wherein the relationship indicates that the unmodulated carrier frequency is a multiple of the data clock frequency.

15. The apparatus of claim 13, wherein the relationship indicates that the unmodulated carrier frequency is an integer multiple of the data clock frequency.

16. The apparatus of claim 13, further comprising:
means for determining the relationship between the data clock frequency and the unmodulated carrier frequency, wherein an indication of the relationship is stored or configured into a transceiver.

17. The apparatus of claim 13, wherein means for recovering the data clock frequency comprises means for dividing the unmodulated carrier frequency by a multiple indicated by the relationship.

18. The apparatus of claim 13, wherein the signal further includes modulated data or a modulated carrier frequency.

19. The apparatus of claim 13, wherein the unmodulated carrier frequency is a residual carrier frequency or a fixed carrier vector.

20. The apparatus of claim 13, further comprising:
means for recovering a symbol timing from the unmodulated carrier frequency based on the relationship.

21. The apparatus of claim 13, wherein the means for locking includes a phase lock loop (PLL) of a transceiver.

22. The apparatus of claim 21, wherein the PLL is configured to operate in a receive (RX) mode or a transmit (TX) mode, and wherein the signal is received when the PLL is configured to operate in the RX mode.

23. An apparatus for near-field communications, comprising:
a receiver configured to receive a signal including an unmodulated carrier frequency from a transmitter; and
at least one processor configured to:
lock onto the unmodulated carrier frequency; and
recover a data clock frequency from the unmodulated carrier frequency based on a relationship between the data clock frequency and the unmodulated carrier frequency.

24. The apparatus of claim 23, wherein the relationship indicates that the unmodulated carrier frequency is a multiple of the data clock frequency.

25. The apparatus of claim 23, wherein the relationship indicates that the unmodulated carrier frequency is an integer multiple of the data clock frequency.

26. The apparatus of claim 23, further comprising:
a divider configured to divide the unmodulated carrier frequency by a multiple indicated by the relationship to recover the data clock frequency.

27. The apparatus of claim 23, wherein the signal further includes modulated data or a modulated carrier frequency.

28. The apparatus of claim 23, wherein the unmodulated carrier frequency is a residual carrier frequency or a fixed carrier vector.

29. The apparatus of claim 23, wherein the at least one processor is further configured to operate in a phase lock loop (PLL), wherein the PLL is configured to operate in a receive (RX) mode or a transmit (TX) mode, and wherein the signal is received when the PLL is configured to operate in the RX mode.

30. The apparatus of claim 23, wherein the signal is a near ultra-low energy field (NULEF) signal.
